(19) United States
(12) Patent Application Publication
(10) Pub. No.: US 2009/0272022 A1
(43) Pub. Date: Nov. 5, 2009

(54) ICE FISHING TIP-UP

(76) Inventor: George Grega, Warminster, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/112,606

(22) Filed: Apr. 30, 2008

(51) Int. Cl. A01K 97/12

(52) U.S. Cl. 43/17

(57) ABSTRACT

An ice fishing tip-up adapted to rest on a sheet of ice surrounding a fishing opening therein, has a rigid frame with an aperture therein, a spool support, a rocker arm and a swing arm. A spool support connects to the frame and supports a spool on which fishing line is wound. The rocker arm includes an elbow pivotally attached to the frame distant the spool support, a catch indicator extending radially outward from the elbow in a first direction, and a rocker forearm extending radially outward from the elbow connector in a second direction. The rocker forearm has a first guide for receipt of the fishing line from the spool. The swing arm includes a swivel connector pivotally attached to the frame and a distal extent opposite the swivel connector with a second guide for receipt of the fishing line from the first guide. In an exemplary embodiment, the fishing line extends from the spool through the first guide, then through the second guide and downwardly therefrom to the fishing opening. A tug of a fish caught on the fishing line pulls the first guide which pivots the rocker arm to a catch position with the rocker forearm extending over the aperture and the catch indicator extending upright as indicia that the fish is caught.

### BACKGROUND OF THE INVENTION

1. Field of Invention

This invention relates to ice fishing tools, and more particularly, to ice fishing tip-ups.

2. Description of Related Art

Ice fishing is the activity of catching fish with lines and fish hooks or spears through an opening in the ice on a frozen body of water. Ice anglers may sit on a stool, a chair on the open expands of a frozen lake, or sit in a heated cabin on the ice. Ice fishing generally involves drilling a hole through ice into lake or pond water, positioning an ice fishing device over the hole, and lowering a fish hook into the water. These devices typically have a reel or spool with a fishing line connected to it which actuates a signaling device, such as a catch indicator or flag to indicate to the fisherman when a fish has been hooked. Ice fishing devices which have a mounted flag are often referred to as “tip-ups”, and are the most common type of ice fishing device. The conventional tip-up includes a base, typically in the form of a board or runners or sufficient length so as to span the ice fishing hole. A fishing line, with hook attached, suspends from a reel or spool mounted on the board to activate a flag or alternative indicia to pop up when a fish engages the hook and exerts sufficient pressure on the line, that is, pulls line from the spool. That is, a typical tip-up includes a cover assembly that rests on the ice to cover the hole, a fishing line and a spool that releases the tip-up alarm when a fish engages the hook and pulls the line from the spool. The fisherman can leave such tip-up devices unattended and can have several tip-ups located at holes in the ice at several different locations.

The prior art discloses a large number of tip-up devices, for example, U.S. Pat. No. 5,896,694 discloses an adjustable ice fishing tip-up including a base frame adapted to span a hole in a layer of ice over a body of water. U.S. Pat. No. 5,067,269 discloses a bias coil spring loaded ice fishing tip-up assembly. U.S. Pat. No. 5,564,213 discloses a fold-up ice fishing rig having a rigid elongated central frame member to span a hole in the ice, including a spool assembly, a line guide, and an arm with a rigid collar connection section. U.S. Pat. No. 5,551,183 discloses a hands-free fishing system with a flag having an eyelet on the distal tip of its arm through which fishing line is run. U.S. Pat. No. 5,020,263 discloses a fish actuated ice fishing signaling device. U.S. Pat. No. 4,373,287 discloses a fishing tip-up using a rocker arm pivotally mounted on a body member. Finally, U.S. Pat. Nos. 1,803,914; 4,685,240; 6,354,036; 5,448,849; and 6,564,496 disclose other ice fishing tip-ups.

One problem often encountered when using tip-ups occurs after a catch. With tip-ups typically covering the hole, it is difficult to access the fishing line to pull in the caught fish by hand. Generally, in order to pull the fish out of the water by hand, the fisherman must move the entire tip-up device away from the hole to easily access the fishing line and allow sufficient space for the fisherman to move his or her arms while pulling the fish out of the water. Accordingly, it would be beneficial to provide an ice fishing tip-up that permits easy access to the fishing line of a caught fish and allows full freedom of motion for the fisherman above the fishing hole without removing the tip-up from the fishing hole.

All references cited herein are incorporated herein by reference in their entireties.

### BRIEF SUMMARY OF THE INVENTION

This invention provides an ice fishing tip-up adapted to rest on a sheet of ice surrounding a fishing opening therein, and having a rigid frame, a spool support, a rocker arm and a swing arm. The rigid frame includes a central aperture larger than a circumference of the fishing opening to expose the entire fishing opening within the aperture. The rigid frame also includes a spool support connected at a first position of the rigid frame for supporting a spool on which fishing line is wound. The rocker arm is pivotally attached at a second position of the rigid frame distant the first position. The rocker arm includes an elbow connector attached to the rigid frame at the second position, a catch indicator extending radially outward from the elbow connector in a first direction, and a rocker forearm extending radially outward from the elbow connector in a second direction. The rocker forearm has an upper extent with a first guide for receipt of the fishing line from the spool. The swing arm is pivotally attached at a third position of the rigid frame distant the second position. The swing arm including a swivel connector attached to the rigid frame at the third position and a distal extent opposite the swivel connector with a second guide for receipt of the fishing line from the first guide. In an exemplary embodiment, the fishing line extends from the spool through the first guide, then through the second guide and downwardly therefrom to the fishing opening. A tug of a fish caught on the fishing line pulls the first guide which pivots the rocker arm to a catch position with the rocker forearm extending over the aperture and the catch indicator extending upright as indicia that the fish is caught.

In a further aspect of this example, the swing arm pivotally attached at the third position of the rigid frame moves from a pre-catch position extending from the swivel connector towards the aperture of the frame and over the fishing opening to a reel-in position extending from the swivel connector away from the aperture and the fishing opening to clear the swing arm above the fishing opening without moving the rigid frame. In another aspect of this example, the rocker arm pivotally attached at the second position of the rigid frame is rotatable to a reel-in position with the rocker forearm extending from the elbow connector away from the aperture to clear the ice fishing tip-up above the fishing opening without moving the rigid frame.

The invention also provides a method of using an ice fishing tip-up having a rigid frame including a central aperture larger than a circumference of a fishing opening. The rigid frame includes a spool support connected at a first position of the rigid frame for supporting a spool on which fishing line is wound. The ice fishing tip-up also has a rocker arm pivotally mounted at a second position of the rigid frame distant the first position. The rocker arm includes an elbow connector mounted to the rigid frame at the second position, a catch indicator extending radially outward from the elbow connector in a first direction, and a rocker forearm extending radially outward from the elbow connector in a second direction. The rocker forearm has an upper extent with a first guide for receipt of the fishing line. The ice fishing tip up also includes a swing arm pivotally mounted at a third position of the rigid frame distant the second position. The swing arm includes a swivel connector attached to the rigid frame at the third position and a distal extent opposite the swivel connector with a second guide for receipt of the fishing line. A tug of a fish caught on the fishing line pulls the first guide which pivots the rocker arm to a catch position with the rocker forearm extending over the aperture and the catch indicator upright as indicia that the fish is caught. The method of using the ice fishing tip-up includes: placing the spool onto the spool support, threading the fishing line from the spool through the first guide and then through the second guide, placing the rigid frame on a sheet of ice surrounding the fishing opening to expose the entire fishing opening within the aperture, pivoting the swing arm to a pre-catch position extending from the swivel connector towards the aperture of the frame and over the fishing opening, inserting the threaded fishing line downward from the second guide into the fishing opening, and pivoting the rocker arm to a pre-catch position with the a catch indicator along the ice and the rocker forearm extending from the elbow connector upwards away from the ice.

In a further aspect of this example, after the indicia that the fish is caught, the method further includes pivoting the rocker arm from the catch position to a reel-in position with the rocker forearm extending from the elbow connector away from the aperture and the fishing opening, and pivoting the swing arm from its pre-catch position to a reel-in position extending from the swivel connector away from the aperture and the fishing opening to clear the ice fishing tip-up above the fishing opening without moving the rigid frame.

In yet another example, this invention provides an ice fishing tip-up adapted to rest on a sheet of ice surrounding a fishing opening therein, and includes a rigid frame, a spool support and a rocker arm pivotally attached to the frame. The rigid frame includes a central aperture larger than a circumference of the fishing opening to expose the entire fishing opening within the aperture. The spool support connects at a first position of the rigid frame for supporting a spool on which a fishing line is wound. The rocker arm is pivotally attached at a second position of the rigid frame distant the first position. The rocker arm includes an elbow connector attached to the rigid frame at the second position, a catch indicator extending radially outward from the elbow connector in a first direction, and a rocker forearm extending radially outward from the elbow connector in a second direction upright from the ice. The rocker forearm has an upper extent with a guide for receipt of the fishing line from the spool. The fishing line extends from the spool through the guide and downwardly therefrom to the fishing opening. A tug of a fish caught on the fishing line pulls the guide which pivots the rocker arm to a catch position with the rocker forearm extending over the aperture and the catch indicator extending upright as indicia that the fish is caught. The rocker forearm is rotatable back to the second direction upright from the ice to clear the ice fishing tip-up above the fishing opening without moving the rigid frame.

### BRIEF DESCRIPTION OF SEVERAL VIEWS OF THE DRAWINGS

The invention will be described in conjunction with the following drawings in which like reference numerals designate like elements and wherein:

FIG. 1 is a perspective view of an exemplary tip-up constructed in accordance with the principles of the preferred embodiments;

FIG. 2 is a side exploded view illustrating a spool support of FIG. 1;

FIG. 3 is a side exploded view of a rocker arm assembly of the exemplary embodiment shown in FIG. 1;

FIG. 4 is a top exploded view of a swing arm assembly of FIG. 1;

FIG. 5 is a side elevational view of the exemplary tip-up shown in FIG. 1 illustrating the tip-up in a set-up position above a sheet of ice;

FIG. 6 is a perspective illustration of the tip-up of FIG. 1 in a catch or fish-on-line orientation;

FIG. 7 is a perspective illustration of the tip-up of FIG. 1 showing the tip-up in a reel-in configuration; and

FIG. 8 is a top elevational view of the tip end in the reel-in configuration.

### DETAILED DESCRIPTION OF THE INVENTION

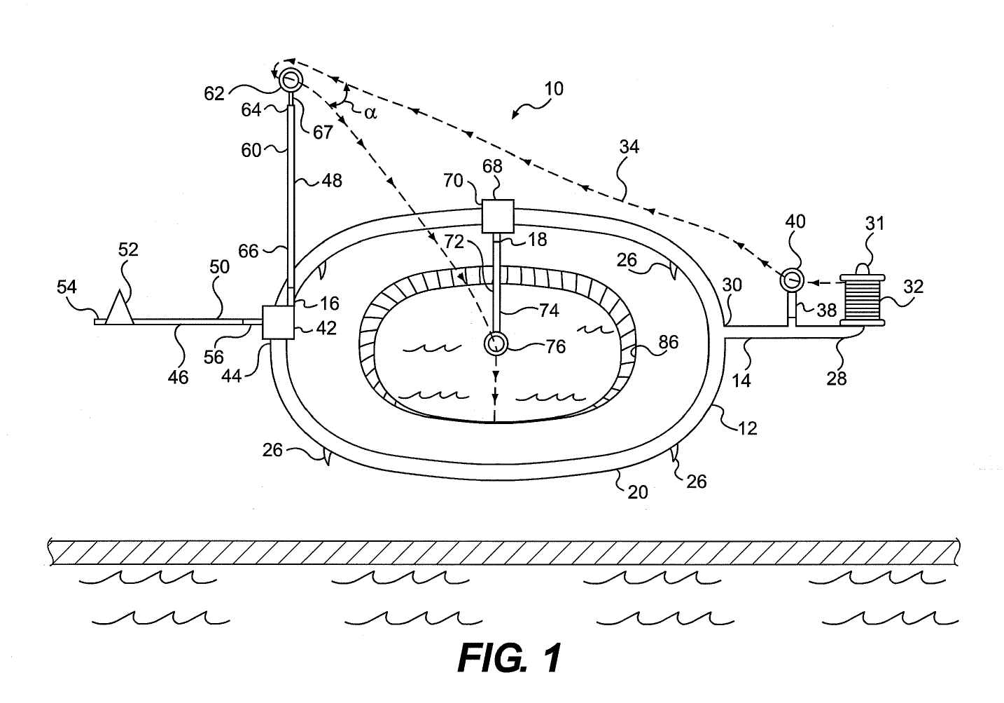

Reference is now made to the drawings, and in particular, to FIG. 1 which depicts an exemplary embodiment of the fishing tip-up generally designated by the numeral 10. In this respect, the tip-up 10 includes a support assembly or frame 12, a spool support 14 fixedly connected to the frame, a rocker arm 16 pivotally attached to the frame, and a swing arm 18 that is also pivotally attached to the frame.

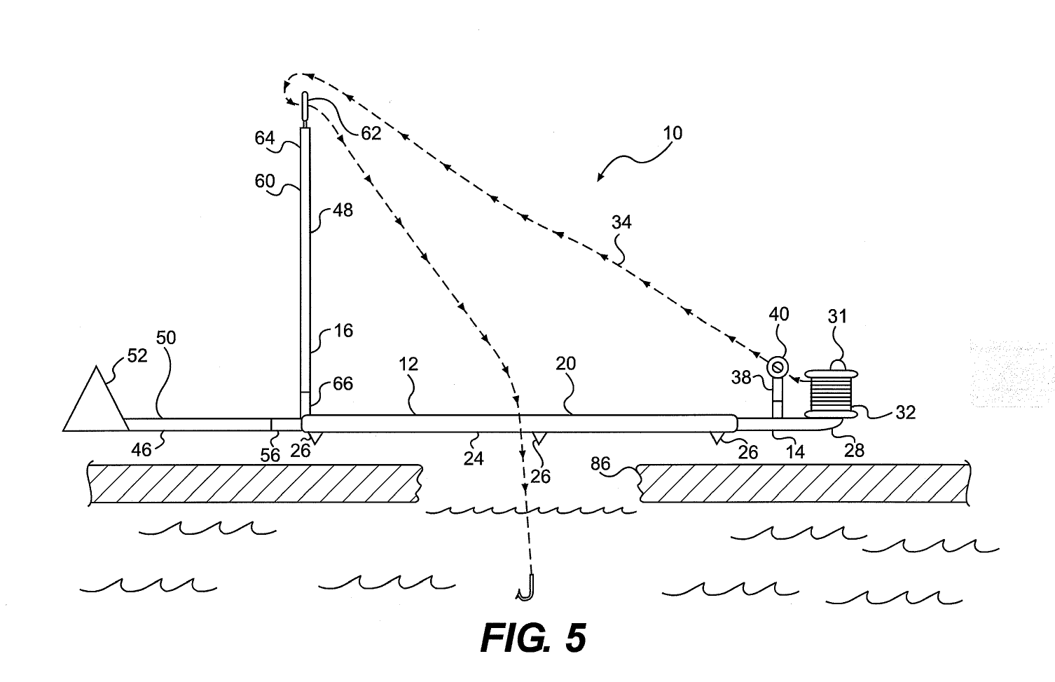

The frame 12 is preferably rigid to rest on a sheet of ice without folding or deforming in a way that would compromise its structural integrity during use. The frame 12 has a rigid base which is preferably formed of a molded plastic (e.g., polycarbonate, PVC) or other high strength material (e.g., wood, metal) in a tubular ring shape. It is understood that the base 20 is not limited to a tubular ring shape, as shown in FIG. 1, and may also be of a round or polygonal shape large enough to surround a fishing home. The frame 12 includes a central aperture 22 within the base 20 that is also larger than the circumference of a fishing hole to expose the entire fishing hole within the aperture. While not being limited to a particular theory, the base has a substantially planar bottom portion 24 (FIG. 5) with spikes 26 extending downward therefrom to help secure the frame 12 to a sheet of ice and prevent slipping of the frame on the ice during use of the tip-up.

Referring now to FIGS. 1, 2 and 5, the spool support 14 is preferably formed of the same molded plastic or high strength material that is used to form the frame 12. The spool support 14 includes a spool arm 28 extended from the frame 12 at a first position 30 of the frame. The spool arm 28 is fixed to the frame 12 preferably by molding the plastic of the spool arm with the frame 12 during the formation of the spool arm 28 so that the spool arm 28 and frame are integrally formed. However, the invention is not limited thereto, as the spool arm 28 may be connected to the frame 12 in any manner that creates a fixed attachment therebetween, for example, by heat, snap fit, threaded engagement, frictional connection, adhesive, staples, brace, etc. Preferably the spool arm 28 is generally tubular in shape as it extends away from the frame 12 opposite the aperture 22. The spool arm includes a distal portion 31 adapted to hold a spool 32 of fishing line 34 that is eventually extended through the fishing hole for fishing. Typically, a fishing hook is connected at the distal end of the fishing line that extends into the water for catching a fish.

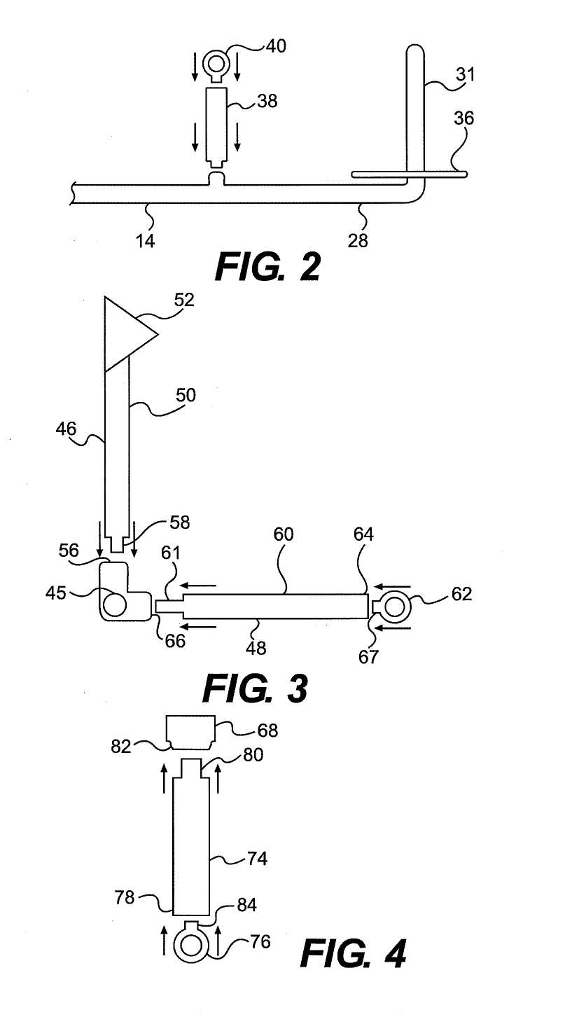

The distal portion 31 shown in the figures is turned upwards from the spool arm 28 at about a 90° angle to prevent the spool from falling off of the spool support 14. As can best be seen in FIG. 2, a washer 16 is coupled to the distal portion of the spool arm as a type of brace to further support the spool and prevent the spool from tipping and tangling the fishing line 34. The washer 36 is preferably formed of metal or plastic, but may also be formed of other materials that allow rotation of the spool 32 on the distal portion 31 and support the spool. It should be noted that the invention is not limited to the particular spool support 14 shown in the figures, as alternative spool support that hold a reel or spool of fishing line for use during fishing are considered within the scope of the invention.

Still referring to FIGS. 1, 2 and 5, the spool support 14 also includes a line guide arm 38 fixedly attached to the spool arm 28. The line guide arm is preferably formed of the same material as the spool arm 28 and is connected to the spool arm 28, preferably by a fixed attachment (e.g., frictional fit, snap fit, threaded engagement) that remains attached during use but can be disassembled for easier storage and transportation of the tip-up 10. The line guide arm 38 includes a line guide eyelet 40 as a type of guide for receipt of the fishing line 34 between the spool 32 and the fishing hole. The eyelet 40 is preferably formed of a hard smooth plastic and may be formed integrally with or separate from the line guide arm 38. Of course, if formed separate from the line guide arm, the line guide eyelet 40 is coupled to the line guide arm 38 during use. FIG. 2, in particular, depicts an exploded view of the line guide arm 38 and line guide eyelet 40 with the spool support 14.

As noted above, frame 12 includes a rocker arm 16 pivotally attached to the frame 12. As can be seen in FIG. 1, the rocker arm includes an elbow 42 as a connector pivotally attached to the frame at a second position 44 of the frame. Preferably, the second position 44 of the frame is opposite the first position 30 of the frame, however, the invention is not limited thereto.

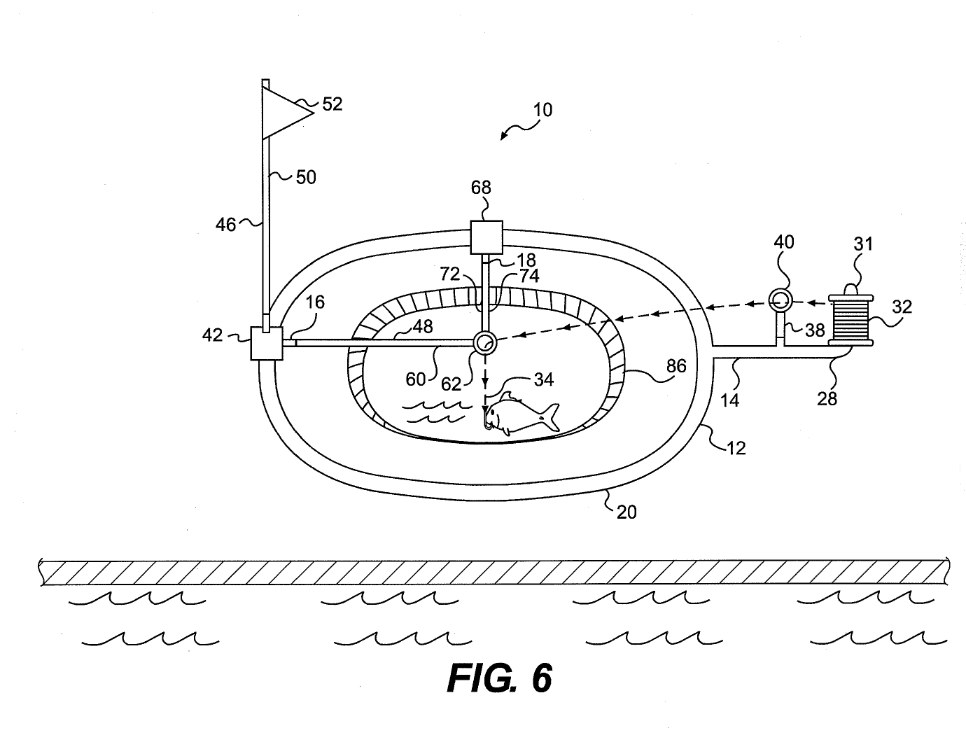

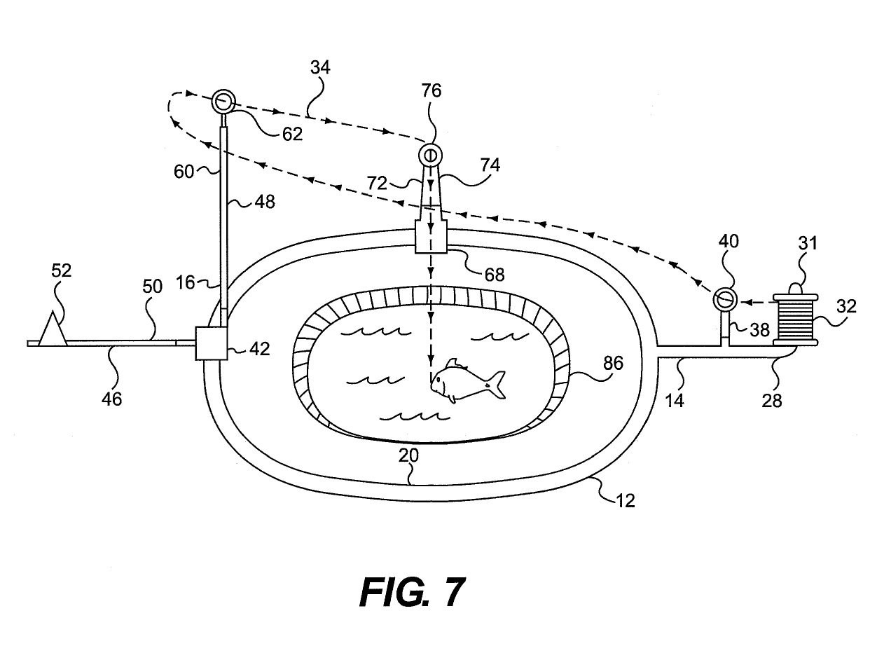

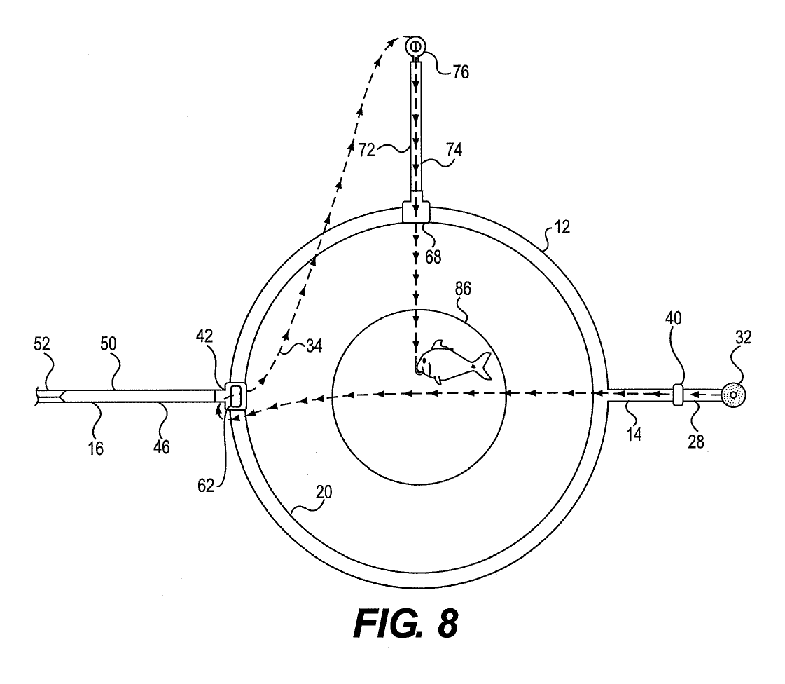

The rocker arm 16 is shown by perspective view in FIG. 1, exploded view in FIG. 3, and side view in FIG. 5, and pivots from a set up position as shown by example in FIGS. 1, 3 and 5 to a catch position (FIG. 6) and then to the reel-in position (FIGS. 7 and 8). The rocker arm 16 includes the elbow 44, a catch indicator 46 extending radially outward from the elbow in a first direction away from the central aperture 22, and a rocker forearm 48 extending radially outward from the elbow in a second direction upwards and preferably perpendicular to the first direction. The elbow 42 is a swivel connector preferably made of hollow plastic with an aperture 45 sized to fit around and radially rotate about the frame 12 at the second position 44.

The catch indicator 46 is coupled to the elbow 42 and includes a flagpole 50 extending radially outward from the elbow in the first direction, and a flag 52 attached to the flagpole at a distal end 54 thereof. The flagpole 50 is preferably made of hard tubular plastic and is constructed to connect to the elbow 42. As can best be seen in FIG. 3, the flagpole 50 may be frictionally coupled to the elbow 42 at an opening 56 of the elbow coupled with a proximal end 58 of the flagpole configured to fit into and connect with the elbow. Preferably, the proximal end 58 has a cross-sectional diameter about the size of the diameter of the opening 56 of the elbow so that the flagpole 50 can fit snugly into the elbow opening. It is understood that the relative sizes of the proximal end 58 of the flagpole and the opening 56 of the elbow are not limited to the disclosed example, as long as the flagpole 50 and elbow 42 are coupled during use of the tip-up 10. For example, the pieces may be integral or separate pieces that are frictionally threaded, snap fitted, molded, or otherwise configured to attach the flagpole to the elbow. The flag 52 is one type of catch indicia that may be used to alert the fisherman of a catch, and alternative catching indicia, such as bright paint, lights, streamers, etc. may be used as an alternative to the exemplary flag. The flag 52 is preferably attached to the flagpole 50 with hot glue. Of course, other approaches may be used within the scope of the invention to attach the flag 52 to the flagpole 50, including staples, string, plastic ties, or other connectors. In the preferred embodiments, the catch indicator 46 is designed to extend away from the central aperture 22 during set up before a catch, and after the catch during reel-in. The catch indicator 46 is designed to pivot upwards to alert the fisherman of a catch, as will be described in greater detail below.

The rocker forearm 48 includes a forearm rod 60 extending radially outward from the elbow 42 and a rocker eyelet 62 attached at an upper extend 64 of the forearm rod. Preferably the forearm rod 60 and rocker eyelet 62 are made of hard tubular plastic and have connectors configured to attach to adjacent members. For example, as can best be seen in FIG. 3, the forearm rod 60 has a proximal end 62 configured to attach to the elbow 42 at a connector 66 thereof. In this example, the proximal end 62 has a transverse diameter about the size of the diameter of the connector 66 opening so as to frictionally fit the proximal end within the connector 66. Further, the forearm eyelet 62 has a male connector 66 adapted to frictionally fit within an opening of the upper extent 64 of the forearm rod. As noted above for the catch indicator 46, the forearm rod 60 and rocker eyelet 62 can be connected to each other and to the elbow 42 by alternative approaches not shown in the figures, as set forth above by example and readily understood by a skilled artisan. The rocker eyelet 62 includes a ring-shaped guide that is preferably smooth for receipt of the fishing line 34 in a similar manner as described above with the line guide eyelet 40. In use, the fishing line 34 that is threaded through the rocker eyelet 62 continues downwardly from the eyelet into the fishing opening as will be described in greater detail below.

Now referring to FIGS. 1 and 4, the swing arm 18 includes a swivel connector 68 pivotally attached to the frame 12 at a third position 70 thereof and a hole guide arm 72 extending from the swivel connector. The hole guide arm 72 includes a swing rod 74 and a swing eyelet 76 connected to a distal extent 78 of the swing rod 74. The swivel connector 68 is preferably formed substantially similar to the elbow 42, but preferably includes only one extension therefrom. In particular, the swivel connector 68 is made of hollow plastic so it can fit around a frame 12 and spin or rotate freely about the frame. The hole guide arm 72 is substantially similar to the rocker forearm 48 and is preferably made with a hard tubular plastic that is connected to and extends from the swivel connector 68. The swing rod 74 is substantially similar to the forearm rod 60. As can best be seen in the exploded view of FIG. 4, the swing rod 74 has a proximal end 80 dimensioned to fit frictionally into and attach to an opening 80 of the swivel connector. The swing rod 74 includes the distal extent 78 that is configured to receive and connect to the male connector 84 of the swing extent 76. The swing eyelet 76 is another fishing line guide made of smooth plastic with a ring for receiving the fishing line 34 from the rocker eyelet 62 and passing the fishing line into the fishing hole during use.

While not being limited to a particular theory, the hole guide arm 72 has a length extending from the swivel connector 68 to the swing eyelet 76 that centers the swing eyelet in the central aperture 22 when the swing arm 18 is extended into the aperture. This allows the swing eyelet 76 to center the fishing line as it passes through the swing eyelet into a fishing hole below. Preferably the rocker forearm 48 also has a length extending into the central aperture 22 that places the rocker eyelet 62 in the center of the aperture adjacent to and in line with the swing eyelet 76. In the most preferred embodiment, the base 20 of the frame 12 is ring-shaped and circular with the lengths of the rocker forearm 48 and the hole guide arm 72 equal so that the rocker eyelet 62 and swing eyelet 76 are aligned when both are placed into the central aperture 22 regardless of the relative locations of their mounting positions (e.g., the second and third position) on the frame.

In use, that is during fishing, the tip-up 10 has three basic positions, a set up position, a catch position, and a reel-in position. In the set up position, which is a pre-catch position before a fish is caught, the spool 32 is placed onto the spool support 14, preferably on the upturned distal portion 31, and most preferably also on the brace 36 of the spool support.

The fishing line 34 from the spool 32 is threaded through the line guide eyelet 40, then through the rocker eyelet 62 and finally through the swing eyelet 66. The fishing line is set with a hook and placed through the fishing opening or hole into the water.

In this set-up position, the tip-up 10 is placed on a sheet of ice surrounding a fishing opening 86 to expose the entire fishing opening within the central aperture 22. As can best be seen in FIGS. 1 and 5, in the set up or pre-catch position, the rocker arm 16 is pivoted so that the rocker forearm 48 extends upward from the elbow 42 and the catch indicator 46 extends along the ice away from the central aperture 22. Further, the swing arm 18 is pivotally positioned with the hole guide arm 72 extending into the central aperture 22 and over the fishing hole 86, and the swing eyelet 76 is positioned in the center of the aperture and over the fishing opening. As can best be seen in FIG. 1, in the set up position, the fishing line 34 fed from the spool 32 through the rocker eyelet 62 and the swing eyelet 76 forms an acute angle at the rocker eyelet 62 caused by the relative locations of the eyelets. This acute angle is formed regardless of if the line guide eyelet 40 is used.

The catch indicator 46 and rocker forearm 48 of the rocker arm 16 are weighted so that the rocker arm remains in its set-up position with the catch indicator extending away from the central aperture 22 and the rocker forearm 48 extending upright unless the rocker arm is moved by an external force, such as by a person pivoting the rocker arm or by a fish pulling on the fishing line 34 when a fish is caught on the fishing line.

A fish caught on the fishing line tugs and pulls the fishing line to the catch position of the tip-up. That is, the caught fish tugs on the fishing line which pulls the rocker eyelet 62 and pivots the rocker arm 16 to its catch position shown by example in FIG. 6, with the rocker forearm extending toward the central aperture 22 and over the fishing hole 86, and the catch indicator 46 at an upright position as indicia that the fish is caught. The tension put on the fishing line 34 caused by the caught fish preferably pulls the rocker eyelet 62 adjacent to and into alignment with the swing eyelet 76, thereby allowing the spool 32 to spin freely until the fishing line is manually stopped.

After the flag 52 is raised as indicia of a catch, the fisherman moves the rocker arm 16 and swing arm 18 to a reel-in position that clears the ice fishing tip-up 10 above the fishing opening and completely exposes the fishing hole 86 to the fisherman to pull the fishing line 34, all without moving the frame 12. That is, the rocker arm 16 is pivoted from the catch position to a reel-in position with the rocker forearm 48 extending from the elbow 42 upwards away from the ice, and with the catch indicator 46 extending along the ice away from the central aperture 22. In the exemplary embodiments, this reel-in position is substantially identical to the setup or pre-catch position shown, for example, in FIGS. 1 and 5. Then the swing arm 18 is also pivoted from its catch position into the central aperture 22 to its reel-in position approximately 180° away with the swing arm now extending away from the central aperture and the fishing opening. Once the rocker arm 16 and the swing arm 18 are moved to their reel-in positions, as can best be seen in FIGS. 7 and 8, the tip-up 10 is no longer positioned above the fishing hole 86, and only the fishing line 34 remains above or within the fishing opening, leaving the fisherman free to access the fishing line without interference from any parts of the tip-up and without actually having to move the tip-up away from the fishing hole. The fisherman can now grab the fishing line 34 and pull in the fishing line without obstruction from the tip-up 10.

It should be noted that the catch indicator 46 and the rocker forearm 48 can be connected to the elbow 42 at an angle more than or less than 90°. While 90° is preferred, an acute angle less than 90° is preferred over an angle greater than 90° as long as each extension of the rocker arm can stand when appropriate and remain under normal forces less than the pull of the line from the fish after catch or the applied force of the fisherman pivoting the rocker arm.

It is understood that the ice fishing tip-up described and shown are exemplary indications of preferred embodiments of the invention, and are given by way of illustration only. In other words, the concept of the present invention may be readily applied to a variety of preferred embodiments, including those disclosed herein. While the invention has been described in detail and with reference to specific examples thereof, it will be apparent to one skilled in the art that various changes and modifications can be made therein without departing from the spirit and scope thereof. Without further elaboration, the foregoing will so fully illustrate the invention that others may, by applying current or future knowledge; readily adapt the same for use under various conditions of service.

What is claimed is:

1. An ice fishing tip-up adapted to rest on a sheet of ice surrounding a fishing opening therein, the ice fishing tip-up comprising:
a rigid frame including a central aperture larger than a circumference of the fishing opening to expose the entire fishing opening within said aperture, said rigid frame having a first position, a second position and a third position;
a spool support fixedly connected at the first position of said rigid frame for supporting a spool on which a fishing line is wound;
a rocker arm pivotally attached at the second position of said rigid frame distant the first position, said rocker arm including an elbow connector attached to said rigid frame at the second position, a catch indicator extending radially outward from said elbow connector in a first direction, and a rocker forearm extending radially outward from said elbow connector in a second direction, said rocker forearm having an upper extent with a first guide for receipt of the fishing line from the spool; and
a swing arm pivotally attached at the third position of said rigid frame distant the second position, said swing arm including a swivel connector attached to said rigid frame at the third position and a distal extent opposite said swivel connector with a second guide for receipt of the fishing line from said first guide, the fishing line extending from the spool through said first guide then through said second guide and downwardly therefrom to the fishing opening, wherein a tug of a fish caught on the fishing line pulls said first guide which pivots said rocker arm to a catch position with said rocker forearm extending over said aperture and said catch indicator extending upright as indicia that the fish is caught.

2. The ice fishing tip-up of claim 1, said spool support including a spool arm extending from the first position of said rigid frame distant the fishing opening.

3. The ice fishing tip-up of claim 2, said spool arm including a distal portion turned upwards, said spool support further including a brace at the distal portion that holds the spool and allows rotation of the spool.

4. The ice fishing tip-up of claim 1, further comprising a third guide connected to said rigid frame between said spool support and the first guide for receipt of the fishing line therebetween.

5. The ice fishing tip-up of claim 1, said swing arm pivotally attached at the third position of said rigid frame moving from a pre-catch position extending from said swivel connector towards said aperture of said frame and over the fishing opening to a reel-in position extending from said swivel connector away from said aperture and the fishing opening to clear said swing arm above the fishing opening without moving said rigid frame.

6. The ice fishing tip-up of claim 5, said rocker arm pivotally attached at the second position of said rigid frame has a reel-in position with said rocker forearm extending from said elbow connector away from said aperture to clear said ice fishing tip-up above the fishing opening without moving said rigid frame.

7. The ice fishing tip-up of claim 1, wherein when in the catch position, said first guide is aligned with and above said second guide.

8. The ice fishing tip-up of claim 1, wherein the fishing line from the spool through said first guide and through said second guide forms an acute angle at said first guide.

9. The ice fishing tip-up of claim 1, said catch indicator including a flag pole extending radially outward to a distal end from said elbow connector in the first direction and a flag attached to said flag pole at the distal end.

10. The ice fishing tip-up of claim 1, said rocker forearm including a forearm rod extending radially outward from said elbow connector in the second direction, and said first guide includes an eyelet.

11. The ice fishing tip-up of claim 1, said swing arm further including a swing rod connected to said swivel connector, and said second guide includes an eyelet.

12. The ice fishing tip-up of claim 1, further comprising spikes extending downward from said frame to secure attachment to the ice.

13. The ice fishing tip-up of claim 1, wherein said frame is ring-shaped.

14. The ice fishing tip-up of claim 1, wherein said elbow connector includes a first bushing radially rotatable around said frame at said second position, and said swivel connector is a second bushing radially rotatable around said frame at said third position

15. The ice fishing tip-up of claim 1, wherein said second position of said frame is opposite said first position of said frame, and said third position of said frame is between said first and second positions.

16. The ice fishing tip-up of claim 1, wherein said catch indicator extends radially outward from said elbow connector in a first direction perpendicular to the second direction.

17. A method of using an ice fishing tip-up having a rigid frame including a central aperture larger than a circumference of a fishing opening, the rigid frame including a spool support connected at a first position of the rigid frame for supporting a spool on which fishing line is wound, the ice fishing tip-up further having a rocker arm pivotally attached at a second position of the rigid frame distant the first position, the rocker arm including an elbow connector attached to the rigid frame at the second position, a catch indicator extending radially outward from the elbow connector in a first direction, and a rocker forearm extending radially outward from the elbow connector in a second direction, the rocker forearm having an upper extent with a first guide for receipt of the fishing line, the ice fishing tip up also having a swing arm pivotally attached at a third position of the rigid frame distant the second position, the swing arm including a swivel connector attached to the rigid frame at the third position and a distal extent opposite the swivel connector with a second guide for receipt of the fishing line, wherein a tug of a fish caught on the fishing line pulls the first guide which pivots the rocker arm to a catch position with the rocker forearm extending over the aperture and the catch indicator upright as indicia that the fish is caught, the method comprising:
(a) placing the spool onto the spool support;
(b) threading the fishing line from the spool through the first guide and then through the second guide;
(c) placing the rigid frame on a sheet of ice surrounding the fishing opening to expose the entire fishing opening within the aperture;
(d) pivoting the swing arm to a pre-catch position extending from the swivel connector towards the aperture of the frame and over the fishing opening;
(e) inserting the threaded fishing line downward from the second guide into the fishing opening; and
(f) pivoting the rocker arm to a pre-catch position with a catch indicator along the ice and the rocker forearm extending from the elbow connector upwards away from the ice.

18. The method of claim 17, further comprising:
(g) after the indicia that the fish is caught, pivoting the rocker arm from the catch position to a reel-in position with the rocker forearm extending from the elbow connector away from the aperture and the fishing opening; and
(h) pivoting the swing arm from its pre-catch position to a reel-in position extending from the swivel connector away from the aperture and the fishing opening to clear the ice fishing tip-up above the fishing opening without moving the rigid frame.

19. An ice fishing tip-up adapted to rest on a sheet of ice surrounding a fishing opening therein, the ice fishing tip-up comprising:
a rigid frame including a central aperture larger than a circumference of the fishing opening to expose the entire fishing opening within said aperture, said rigid frame having a first position and a second position;
a spool support fixedly connected at the first position of said rigid frame for supporting a spool on which a fishing line is wound; and
a rocker arm pivotally attached at the second position of said rigid frame distant the first position, said rocker arm including an elbow connector attached to said rigid frame at the second position, a catch indicator extending radially outward from said elbow connector in a first direction, and a rocker forearm extending radially outward from said elbow connector in a second direction upright from the ice, said rocker forearm having an upper extent with a guide for receipt of the fishing line from the spool, the fishing line extending from the spool through said guide and downwardly therefrom to the fishing opening,
wherein a tug of a fish caught on the fishing line pulls said guide which pivots said rocker arm to a catch position with said rocker forearm extending over said aperture and said catch indicator extending upright as indicia that the fish is caught, said rocker forearm then rotatable back to the second direction upright from the ice to clear the ice fishing tip-up above the fishing opening without moving the rigid frame.
